(19) United States
(12) Patent Application Publication
(10) Pub. No.: US 2005/0012765 A1
(43) Pub. Date: Jan. 20, 2005

(54) System and method for marking material container identification

(75) Inventors: Eric A. Merz, Palmyra, NY (US); Donna F. Delmonte, Rochester, NY (US)

Correspondence Address: Patrick D. Floyd;FAY, SHARPE, FAGAN, MINNICH & McKEE, LLP, SEVENTH FLOOR, 1100 SUPERIOR AVENUE, CLEVELAND, OH, 44114-2579, US

(73) Assignee: Xerox Corporation

(21) Appl. No.: 10/758,406

(22) Filed: Jan. 15, 2004

Related U.S. Application Data
(60) Provisional application No. 60/487,822, filed on Jul. 16, 2003.

(51) Int. Cl. B41J 2/195

(52) U.S. Cl. 347/7

(57) ABSTRACT

A system and method of obtaining information from a marking material container is disclosed. The method includes providing a marking material container having a phosphorescent material with predetermined phosphor properties for emitting light with characteristics corresponding to the information, shining light at a container position for a period of time, sensing for emitted light coming from the phosphorescent material, determining the characteristics of the emitted light, and generating the information. The system includes a marking material container having a phosphorescent material with predetermined phosphor properties for emitting light with characteristics corresponding to the information, a light source for producing a light beam directed towards the phosphorescent material, a photo detector for detecting light emitted from the phosphorescent material, and a controller for determining characteristics of the light detected by the photo detector to provide information.

### CROSS REFERENCE TO RELATED APPLICATIONS

This application claims the benefit of U.S. Provisional Application No. 60/487,822 filed Jul. 16, 2003.

### BACKGROUND

The present invention relates to a system and method of obtaining information from a marking material container, and more particularly a system and method of obtaining information from a marking material container using a phosphorescent material.

The marking material used in printing, such as ink, is often housed in a marking material container such as an ink cartridge. The ink cartridge can easily be removed and replaced with a full one when the ink runs low. Some printers, such as inkjet printers, should not be used without ink since dry firing the print heads can be damaging. Therefore, it is desirable to detect the presence and/or absence of the ink cartridge in the printer.

Ink cartridge often contain ink having specific properties suitable for the particular printer for which the cartridge is used. For example, some print heads require inks having a narrow range of properties to enable the printer to operate optimally. Substituting ink with properties outside of these ranges can result in degraded performance or even damage. Some inks have properties which make them incompatible with certain printers. For example, some inks are dye based and others are pigment based and using the wrong ink in a printer can cause coagulation which clogs print heads effectively rendering the machine inoperative. Accordingly, it is desirable for the printer to obtain information about the ink contained in the cartridge to ensure compatibility and optimum performance.

Similarly, copiers can require a marking material, such as toner, having particular properties for proper performance. It is therefore also desirable for the copier to obtain information about the toner contained in the marking material container, such as a toner cartridge, to ensure compatibility and optimum performance.

Conventional techniques for ensuring that the proper marking material is used includes using a container with unique physical properties. For example, using an ink cartridge having a unique pre-defined housing ensures that the cartridge will be the only one to fit into the printer. However, this technique can increase manufacturing costs. Another technique includes obtaining information about a marking material container using reflective materials, such as mirrors and/or prisms, having reflective properties which correspond to particular container information. Light is shined on the reflective material and the intensity of the light reflected back from the reflective material represents the cartridge information. This technique can be inconsistent and may not provide enough gradations to identify a suitable number of cartridges. It is therefore desirable to provide a new and improved system and method of obtaining information from a marking material container.

### BRIEF DESCRIPTION

A system and method of obtaining information from a marking material container is provided.

In accordance with a first aspect of the invention a method is disclosed including providing a marking material container having a phosphorescent material with predetermined phosphor properties for emitting light with characteristics corresponding to the information, shining light at a container position for a period of time, sensing for emitted light coming from the phosphorescent material, determining the characteristics of the emitted light, and generating the information.

In accordance with a second aspect of the invention, a marking material container is provided. The marking material container includes a phosphorescent material with predetermined phosphor properties for emitting light with characteristics corresponding to the information.

In accordance with another aspect of the invention, a system for obtaining information from a marking material container is provided. The system includes a marking material container for hold a marking material and having a phosphorescent material with predetermined phosphor properties for emitting light with characteristics corresponding to the information, a light source for producing a light beam directed towards the phosphorescent material, a photo detector for detecting light emitted from the phosphorescent material, and a controller for determining characteristics of the light detected by the photo detector to provide information.

In accordance with yet another aspect of the invention, a printer/copier is provided. The printer/copier includes a marking material container with a phosphorescent material having predetermined phosphor properties for emitting light with characteristics corresponding to marking material container and/or marking material information, a light source for producing light directed towards the phosphorescent material, a photo detector for detecting light emitted from the phosphorescent material, and a controller for determining characteristics of the light detected by the photo detector and generating the information.

Other features, benefits and advantages of this invention will become apparent to those skilled in the art from the following detailed description of the preferred embodiments, when read in light of the accompanying drawings.

### BRIEF DESCRIPTION OF THE DRAWINGS

The drawings are only for purposes of illustrating preferred embodiments and are not to be construed as limiting the invention. The invention may take form in various components and arrangements of components, and in various steps and arrangements of steps, preferred embodiments of which will be illustrated in the accompanying drawings wherein:

FIG. 1 is block diagram illustrating the invention;

FIG. 2 illustrates the steps of the invention;

FIG. 3 is plot of photo detector signals in response to different phosphor levels in different phosphorescent materials.

### DETAILED DESCRIPTION

It is to be understood that the specific devices and processes illustrated in the attached drawings, and described in the following specification are simply exemplary embodiments of the inventive concepts defined in the appended claims. Hence, specific examples and characteristics relating to the embodiments disclosed herein are not to be considered as limiting, unless the claims expressly state otherwise.

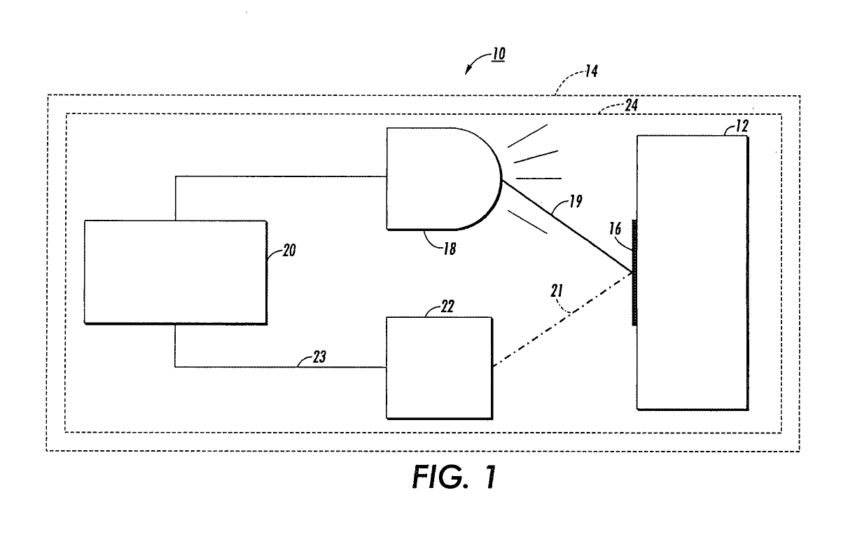

Referring now to FIG. 1, a block diagram illustrating a system for obtaining information from a marking material container is shown generally at 10. The system 10 includes a marking material container shown generally at 12. The marking material container 12 can be a cartridge or any other suitable known container for holding any suitable known marking material for use with a printer/copier shown generally at 14. The term “printer/copier” as used herein refers to any known printer, or copier, or multifunction device which can provide printing and/or copying functions, as well as perhaps other functions, which use one or more marking material containers. For example, the printer/copier 14 can be an ink jet printer, such as a thermal ink jet printer, or any other known printer, including but not limited to piezoelectric printers, dot matrix printers and printers driven by signals from scanners or other image processing devices.

The marking material container 12 contains a marking material which is supplied to the printer/copier marking engine (not shown), such as for example to a printhead or photoconductive member, for producing marks on a substrate, such as paper and the like in any suitable known manner. The marking material can be ink, such as dry ink, liquid ink or solid ink, or any other suitable known ink or any suitable known toner for making marks on a substrate. The container 12 is detachably connected to the marking engine and can be replaced when the marking material is depleted therefrom.

The system 10 also includes a phosphorescent material 16. The phosphorescent material 16 is disposed on the cartridge 12, such as on the outside surface of the cartridge. Although, alternatively it can be contained within the cartridge. The phosphorescent material 16 has predetermined phosphor properties as described in further details below.

The system also includes a light source 18 capable of shining light, herein called incident light 19, on the phosphorescent material 16 for a period of time and shutting off. The light source 18 is controlled by a controller 20. The controller 20 can control when the light 18 is turned on, how long the light is on, and when the light is turned off.

The system 10 also includes a sensor 22 for sensing emitted light, shown at 21, coming from the phosphorescent material 16. The sensor 22 can be any known sensor, such as a photo detector, for detecting light and producing an electrical signal representative thereof. The electrical signal is provided to the controller 20 at 23. The sensor 22 is controlled by the controller 20. Typically, the sensor 22 detects the emitted light 21 from the phosphorescent material 16 after the light source 18 is turned off.

The controller 20, light source 18 and sensor 22 can be disposed in the printer/copier 14 separated from the cartridge 12. The controller 20 can be operated by the printer/copier master controller (not shown). Alternatively, the controller 20, light source 18 and sensor 22 can be disposed in a user replaceable unit shown at 24 along with the cartridge 12 and patch 16. In this configuration, the printer 14 is connected to the controller 20 via a connection (not shown). In another alternate configuration, the light source 18 and sensor 22 can be disposed in the user replaceable unit shown at 24 along with the cartridge 12 and patch 16 and the controller 20 can be disposed in printer. Any other suitable configuration of these components can also be used.

The phosphor of the phosphorescent material 16 has phosphor properties which determine the characteristics of the emitted light 21 coming from the phosphorescent material 16. The phosphor properties can include emission properties such as decay rate which describe how quickly the amplitude of the intensity of the emitted light decreases after the light source 18 is turned off. The decay rate can be defined by a time constant in a known manner.

The emission properties can also include the emissions wavelength which describes the wavelength or wavelengths of light emitted by the phosphorescent material 16. The emission properties can also include the efficiency of emission which describes the amount or intensity of emitted light 21 compared to the incident light 19.

The phosphor properties can also include absorption properties such as the absorption wavelength which describes the wavelength or wavelengths of light absorbed by phosphorescent material 16. Wavelengths absorbed by the phosphorescent material 16 will not be emitted, or will be emitted at lower intensities than wavelengths not absorbed which can be determined from the characteristics of the emitted light 21.

The light source 18 can be matched with the phosphor in the phosphorescent material 16 to more precisely control the emitted light characteristics determined by the phosphor's absorption properties. For example, a light source emitting light with particular wavelengths can be used. The detector 22 can be matched with the phosphor in the phosphorescent material 16 to more precisely control the emitted light characteristics determined by the phosphor's emission properties. For example, detectors sensitive to particular wavelengths can be used.

The phosphor properties of the phosphorescent material 16 can be manipulated to produce emitted light having distinctive characteristics. The emission properties and absorption properties of the phosphor can be manipulated by varying the kinds of phosphors used, and the levels and/or presence or absence of phosphor materials in the phosphor. The characteristics of the emitted light 21 can be used to provide the marking material and/or marking material container information when the light is sensed by the photo detector 22 and analyzed by the controller 20. Therefore, a phosphorescent material 16 having predetermined phosphor properties can be used with a corresponding marking material container so that the characteristics of the emitted light can be used to provide information about the marking material and/or marking material container.

This information can be any suitable information, including but not limited to, specific properties of the marking material within the marking material container. These properties can include, but are not limited to, color, density, whether the ink is dye based or pigment based, etc. Other marking material container information can include, but are not limited to, manufacturer of the marking material container and/or the marking material, place of manufacture, date of manufacture, etc.

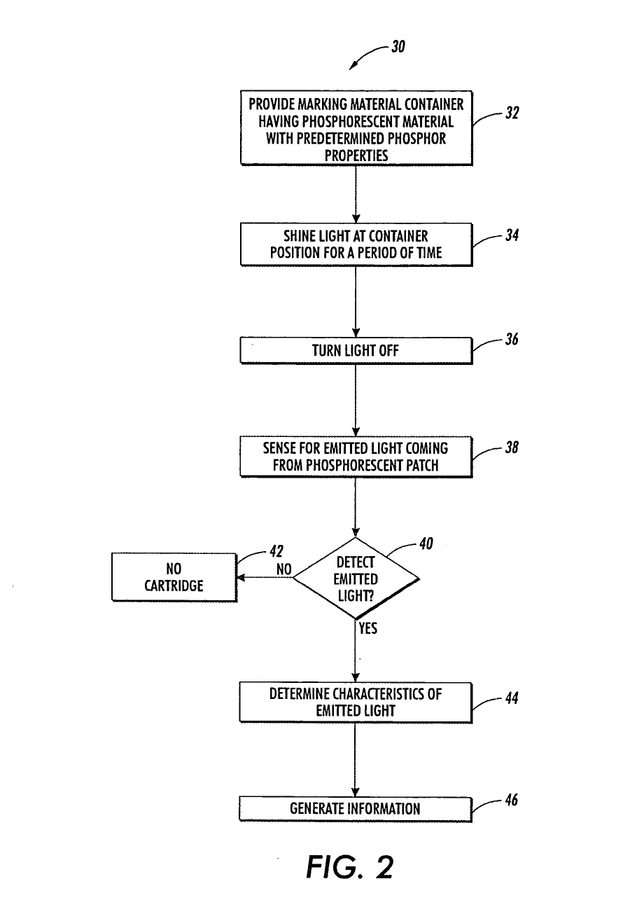

Referring now to FIG. 2, a method for obtaining information from a marking material container 12 is shown generally at 30. The method 30 includes providing a marking material container having a phosphorescent material 16 with predetermined phosphor properties at 32. The marking material container 12 can be any known marking material container having the phosphorescent material as described above. The method 30 also includes shining light 19 at the container position at 34 for a period of time. The container position can be any suitable location in the printer/copier 14 where the marking material container 12 should be disposed. The method 30 can also include turning off the light source at 36.

The method 30 also includes sensing for emitted light 21 coming from the phosphorescent material 16 at 38. If no emitted light 21 is detected at 40, the controller 20 can determine that no marking material container 12 is present at the container position at 42.

If emitted light 21 is detected by the photo detector 22, the photo detector produces a signal representing the light and sends the signal to the controller 20 at 23. The method 30 can also include determining the characteristics of the emitted light 21 coming from the phosphorescent material 16 at 44. The characteristics of the emitted light 21 can include, but are not limited to, intensity, wavelength, and time constant of phosphorescence as determined by the predetermined phosphor properties as described above.

The controller 20 determines the characteristics of the emitted light using the signal 23 provided by the photo detector 22. The controller 20 can also use other information such as the time when the light source 18 was turned off for determining the characteristics of the emitted light. For example, the time constant of phosphorescence can be determined by measuring the intensity of the emitted light 21 over time beginning when the light source 19 was turned off.

The method 30 can also include generating the information at 46. As described above, the characteristics of the emitted light 21 correspond to the information. This correspondence can be accessed by the controller 20, such as for example in a database or in any suitable known manner for use in generating the information. The information can be used to verify that the correct marking material container 12 and/or marking material is being used for the particular marking application. This information can be used to control the printer/copier 14 in any suitable known manner such as placing it in standby mode or providing an error message to the user.

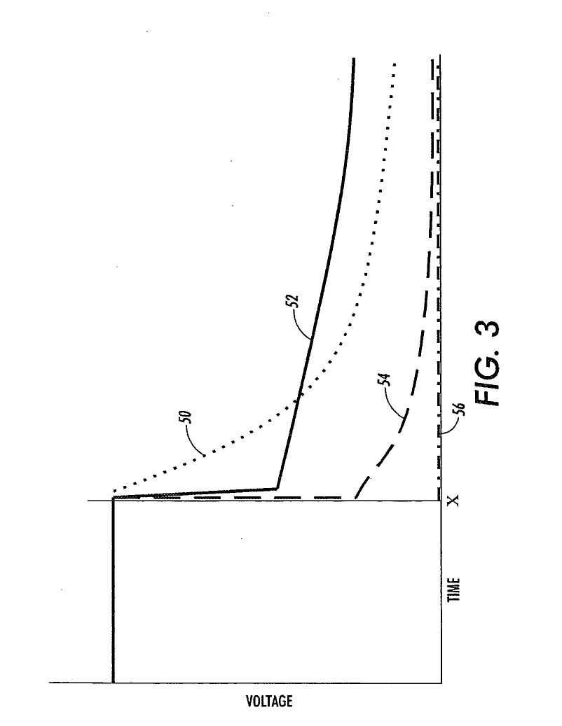

Referring now to FIG. 3, the signals produced by the photo detector 22 for light emitted from three different phosphors in three different phosphorescent materials 16 are shown at 50, 52 and 54. The intensity of the emitted light is represented by the voltage of the photo detector signal. The light source 18 is turned off at time X. The intensity represented by signal 50 is the greatest, that of 52 is the next highest and that of 54 is the lowest. Signal 50 has the shortest time constant, and signal 52 has the longest time constant.

Also the signal representing the absence of emitted light, such as when the marking material container is not present in the container position, is shown at 56. The characteristics of the emitted light, corresponding to the marking material container information, can be determined by the controller using these signals 50, 52, 54, 56.

The invention has been described with reference to preferred embodiments. Obviously, modifications and alterations will occur to others upon reading and understanding the preceding specification. It is intended that the invention be construed as including all such modifications and alterations insofar as they come within the scope of the appended claims or the equivalents thereof.

1. A method for obtaining information from a marking material container comprising:
providing a marking material container having a phosphorescent material with predetermined phosphor properties for emitting light with characteristics corresponding to the information;
shining light at a container position for a period of time; and
sensing for emitted light coming from the phosphorescent material.

2. The method defined in claim 1 further comprising:
determining the characteristics of the emitted light; and
generating the information.

3. The method defined in claim 2 wherein the information identifies the marking material container.

4. The method defined in claim 2 wherein the information identifies the marking material in the marking material container.

5. The method defined in claim 2 wherein the information identifies the manufacturer of at least one of the marking material and the marking material container.

6. The method defined in claim 2 wherein the information is date information.

7. The method defined in claim 2 wherein the marking material is dry ink.

8. The method defined in claim 2 wherein the marking material is liquid ink.

9. The method defined in claim 2 wherein the marking material is solid ink.

10. The method defined in claim 2 wherein the marking material is toner.

11. The method defined in claim 1 wherein the phosphor properties includes emission properties.

12. The method defined in claim 11 wherein the emission properties include an emissions decay rate.

13. The method defined in claim 11 wherein the emission properties include an emission wavelength.

14. The method defined in claim 11 wherein the emission properties include efficiency of emission.

15. The method defined in claim 1 wherein the phosphor properties includes absorption properties.

16. The method defined in claim 15 wherein the absorption properties include an absorption wavelength.

17. The method defined in claim 15 further comprising:
providing a light source for producing light having properties which are matched to the absorption properties of the phosphorescent material.

18. The method defined in claim 11 further comprising:
providing a photo detector having detection properties which are matched to the emission properties of the phosphorescent material.

19. The method defined in claim 1 wherein the marking material container is not disposed in the container position further comprising:
generating a signal indicating that the marking material container is not disposed in the container position.

20. A marking material container for holding a marking material comprising a phosphorescent material having predetermined phosphor properties for emitting light having characteristics for providing information.

21. The marking material container defined in claim 20 wherein the information identifies the marking material container.

22. The marking material container defined in claim 20 wherein the information identifies the marking material.

23. The marking material container defined in claim 20 wherein the information identifies the manufacturer of at least one of the marking material and the marking material container.

24. The marking material container defined in claim 20 wherein the information is date information.

25. The marking material container defined in claim 20 wherein the marking material is dry ink.

26. The marking material container defined in claim 20 wherein the marking material is liquid ink.

27. The marking material container defined in claim 20 wherein the marking material is solid ink.

28. The marking material container defined in claim 20 wherein the marking material is toner.

29. The marking material container defined in claim 20 wherein the phosphor properties includes emission properties.

30. The marking material container defined in claim 29 wherein the emission properties include an emissions decay rate.

31. The marking material container defined in claim 29 wherein the emission properties include an emission wavelength.

32. The marking material container defined in claim 29 wherein the emission properties include efficiency of emission.

33. The marking material container defined in claim 20 wherein the phosphor properties includes absorption properties.

34. The marking material container defined in claim 33 wherein the absorption properties include an absorption wavelength.

35. A system for obtaining information from a marking material container comprising:
a marking material container for holding a marking material and having a phosphorescent material with predetermined phosphor properties for emitting light with characteristics corresponding to the information;
a light source for producing a light beam directed towards the phosphorescent material;
a photo detector for detecting light emitted from the phosphorescent material; and
a controller for determining characteristics of the light detected by the photo detector and generating the information.

36. The system defined in claim 35 wherein the information identifies the marking material container.

37. The system defined in claim 35 wherein the information identifies the marking material.

38. The system defined in claim 35 wherein the information identifies the manufacturer of at least one of the marking material and the marking material container.

39. The system defined in claim 35 wherein the information is date information.

40. The system defined in claim 35 wherein the marking material is dry ink.

41. The system defined in claim 35 wherein the marking material is liquid ink.

42. The system defined in claim 35 wherein the marking material is solid ink.

43. The system defined in claim 35 wherein the marking material is toner.

44. The system defined in claim 35 wherein the phosphor properties includes emission properties.

45. The system defined in claim 44 wherein the emission properties include an emissions decay rate.

46. The system defined in claim 44 wherein the emission properties include an emission wavelength.

47. The system defined in claim 44 wherein the emission properties include efficiency of emission.

50. The system defined in claim 35 wherein the phosphor properties includes absorption properties.

51. The system defined in claim 50 wherein the absorption properties include an absorption wavelength.

52. A printer/copier comprising:
a marking material container for holding a marking material and having a phosphorescent material with predetermined phosphor properties;
a light source for producing light directed towards the phosphorescent material;
a photo detector for detecting light emitted from the phosphorescent material; and
a controller for determining characteristics of the light detected by the photo detector and generating information.

53. The printer/copier defined in claim 52 wherein the information identifies the marking material container.

54. The printer/copier defined in claim 52 wherein the information identifies the marking material.

55. The printer/copier defined in claim 52 wherein the information identifies the manufacturer of at least one of the marking material and the marking material container.

56. The printer/copier defined in claim 52 wherein the information is date information.

57. The printer/copier defined in claim 52 wherein the marking material is dry ink.

58. The printer/copier defined in claim 52 wherein the marking material is liquid ink.

59. The printer/copier defined in claim 52 wherein the marking material is solid ink.

60. The printer/copier defined in claim 52 wherein the marking material is toner.

61. The printer/copier defined in claim 52 wherein the phosphor properties includes emission properties.

62. The system defined in claim 61 wherein the emission properties include an emissions decay rate.

63. The system defined in claim 61 wherein the emission properties include an emission wavelength.

64. The system defined in claim 61 wherein the emission properties include efficiency of emission.

65. The printer/copier defined in claim 52 wherein the phosphor properties includes absorption properties.

66. The system defined in claim 65 wherein the absorption properties include an absorption wavelength.
